(19) United States
(12) Patent Application Publication
(10) Pub. No.: US 2006/0050512 A1
(43) Pub. Date: Mar. 9, 2006

(54) Ultra-high pressure discharge lamp unit and light source apparatus

(75) Inventors: Atsuji Nakagawa, Himeji-City (JP); Tomihiko Ikeda, Himeji-City (JP)

Correspondence Address: JORDAN AND HAMBURG LLP, 122 EAST 42ND STREET, SUITE 4000, NEW YORK, NY, 10168, US

(73) Assignee: Phoenix Electric Co., Ltd., Himeji-City (JP)

(21) Appl. No.: 11/061,496

(22) Filed: Feb. 18, 2005

(30) Foreign Application Priority Data
Sep. 3, 2004 (JP) 2004-257479

(51) Int. Cl. F21V 29/00

(52) U.S. Cl. 362/264; 362/373; 362/345; 362/294

(57) ABSTRACT

An ultra-high pressure discharge lamp unit is provided which satisfies both of the demand for enhanced brightness and the demand for prolonged lifetime. The ultra-high pressure discharge lamp unit includes: a reflector having a concave reflective surface; an ultra-high pressure discharge lamp; and a translucent cover, the reflector having sidewall defining an exhaust vent hole opening into an air passage defined to extend along an external surface of the reflector. When air flows through the air passage, a flow rate difference results between the exterior and the interior of the reflector and, hence, the pressure exerted on the exterior along which air flows at a higher flow rate becomes lower than that exerted on the interior. Accordingly, heated air within the reflector is discharged out of the reflector through the exhaust vent hole by suction caused by the relatively low pressure.

### BACKGROUND OF THE INVENTION

1. Field of the Invention

The present invention relates to an ultra-high pressure discharge lamp unit and a light source apparatus, which are for use in a projector configured to project information displayed by an imaging device through a projection optical system.

2. Description of the Related Art

In recent years, projectors are being used in various scenes such as business presentation, home theater, and rear projection TV. A light source apparatus used as a principal component of such a projector usually includes a discharge lamp unit having a discharge lamp fitted to a reflector having a concave reflective surface.

Such a light source apparatus is strongly desired to have enhanced brightness. Conventionally, such a demand has been satisfied by using an increased pressure discharge lamp (made by encapsulating mercury at a pressure of 0.15 mg/mm³ or more within the lamp) or a discharge lamp of a reduced size (having a bulb wall loading of 0.8 W/mm² or more), or by like measures. A high frequency of explosion is essential to such an increased pressure discharge lamp. For this reason, it has been a conventional practice to fit a cover over the opening portion of the reflector in order to prevent scattering of splinters and mercury upon possible lamp explosion (see U.S. Pat. No. 6,509,674.)

Conventionally, it has been difficult to dissipate heat from the interior of the reflector toward the exterior because of the cover fitted over the opening portion of the reflector and, hence, the temperature of the discharge lamp is elevated too much. This results in the discharge lamp having a shortened lifetime contrary to the demand for prolonged lifetime. Particularly where the discharge lamp is reduced in size for enhanced brightness, this problem is conspicuous because the temperature within the reflector is easy to rise.

Accordingly, an object of the present invention is to provide an ultra-high pressure discharge lamp unit which can satisfy both of the demand for enhanced brightness and the demand for prolonged lifetime.

Another object of the present invention is to provide a light source apparatus using such an ultra-high pressure discharge lamp unit.

### SUMMARY OF THE INVENTION

According to one aspect of the present invention, there is provided an ultra-high pressure discharge lamp unit comprising: a reflector having a concave reflective surface; an ultra-high pressure discharge lamp fitted to a central portion of the reflector; and a translucent cover fitted over an opening portion of the reflector, the reflector having sidewall defining an exhaust vent hole opening into an air passage defined to extend along an external surface of the reflector.

With this construction, when air flows through the air passage, a flow rate difference results between the exterior and the interior of the reflector and, hence, the pressure exerted on the exterior along which air flows at a higher flow rate becomes lower than that exerted on the interior. Accordingly, heated air within the reflector is discharged out of the reflector through the exhaust vent hole by suction caused by the reduced pressure.

In an embodiment of the present invention, the sidewall of the reflector defines an intake vent hole at a location apart from the air passage.

With this feature, as heated air within the reflector is discharged out of the reflector through the exhaust vent by suction caused by the negative pressure, relatively cool external air is taken into the reflector through the intake vent hole.

In another embodiment of the present invention, the opening portion of the reflector and the cover define therebetween an air intake channel providing air communication between an interior and an exterior of the reflector.

With this feature, as heated air within the reflector is discharged out of the reflector through the exhaust vent by suction caused by the negative pressure, relatively cool external air is taken into the reflector through the air intake channel.

In another embodiment of the present invention, the sidewall of the reflector is provided with a duct narrowing the air passage at a location adjacent to the exhaust vent hole.

With this feature, since the air passage is narrowed by the duct, the flow rate of air at the narrowed portion of the air passage is increased by the Venturi effect, which result in a further reduced pressure. Accordingly, the pressure difference between the exterior and the interior of the reflector is further increased, thus causing air within the reflector to be discharged out of the reflector through the exhaust vent hole more rapidly.

In another embodiment of the present invention, the reflector is formed from metal.

With this feature, the reflector formed from metal having a high thermal conductivity enjoys an enhanced heat dissipation effect.

In another embodiment of the present invention, the ultra-high pressure discharge lamp has a discharge tube of quartz glass in which are encapsulated tungsten electrodes, mercury at a pressure of 0.15 mg/mm³ or more, a rare gas, and a halogen, and which has a bulb wall loading of 0.8 W/mm² or more.

With this feature, the ultra-high pressure discharge lamp unit uses a small-sized ultra-high pressure discharge lamp including a discharge tube in which mercury is encapsulated at a high pressure (0.15 mg/mm³ or more) and having a bulb wall loading of 0.8 W/mm² or more. Thus, the discharge lamp unit exhibits enhanced brightness.

According to another aspect of the present invention, there is provided a light source apparatus comprising: an ultra-high pressure discharge lamp unit as recited above; an air passage defined to extend along an external surface of the reflector; and a fan for supplying air to the air passage.

With this construction, when air supplied from the fan flows through the air passage extending along the external surface of the reflector, a pressure difference results between the exterior and the interior of the reflector and, accordingly, heated air within the reflector is discharged out of the reflector through the exhaust vent hole by suction caused by the reduced pressure exerted on the exterior.

The ultra-high pressure discharge lamp unit according to the present invention uses an ultra-high pressure discharge lamp and hence ensures sufficient brightness. Further, the ultra-high pressure discharge lamp unit allows a pressure difference to result between the exterior and the interior of the reflector when air is flown through the air passage extending along the external surface of the reflector, and the resulting pressure difference can cause heated air within the reflector to be discharged out of the reflector. Accordingly, it is possible to suppress a temperature rise within the reflector and prevent the ultra-high pressure discharge lamp from exploding. This means that the ultra-high pressure discharge lamp unit of the present invention can satisfy both of the demand for enhanced brightness and the demand for prolonged lifetime.

If the ultra-high pressure discharge lamp unit is provided with the duct narrowing the air passage, the flow rate of air can be increased by the Venturi effect brought by narrowing the air passage, which results in a further increased pressure difference between the exterior and the interior of the reflector. Accordingly, the discharge lamp unit allows air within the reflector to be discharged through the exhaust vent hole more rapidly, which results in an enhanced cooling effect.

The foregoing and other objects, features and attendant advantages of the present invention will become more apparent from the reading of the following detailed description of the invention in conjunction with the accompanying drawings.

### BRIEF DESCRIPTION OF THE DRAWINGS

FIG. 1 is a sectional view showing an ultra-high pressure discharge lamp unit embodying the present invention;

FIG. 2 is a sectional view showing a light source apparatus including the ultra-high pressure discharge lamp unit;

FIG. 3 is a sectional view showing an ultra-high pressure discharge lamp unit having an intake vent hole according to the present invention;

FIG. 4 is a sectional view showing an ultra-high pressure discharge lamp unit having an air intake channel according to the present invention;

FIG. 5 is a sectional view showing an ultra-high pressure discharge lamp unit having a duct according to the present invention; and

FIG. 6 is a sectional view showing an ultra-high pressure discharge lamp unit including a reflector formed from metal according to the present invention.

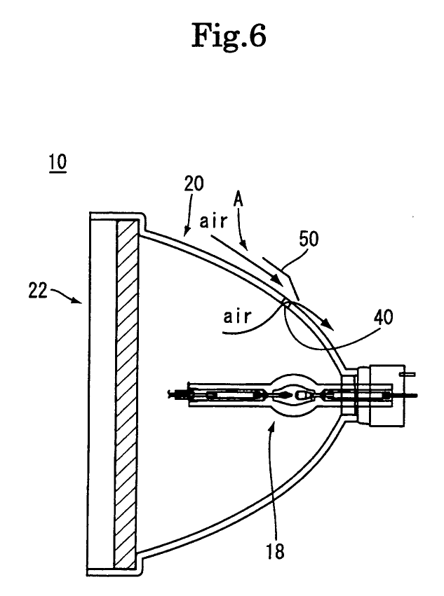

### DETAILED DESCRIPTION OF THE PREFERRED EMBODIMENTS

The present invention will now be described in detail with reference to the accompanying drawings.

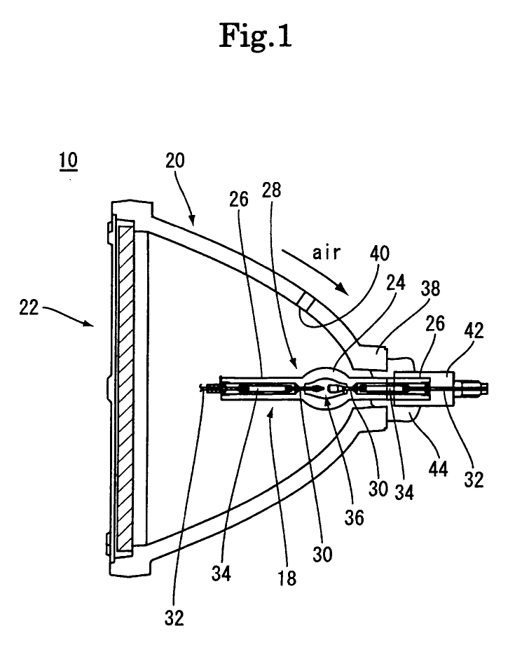

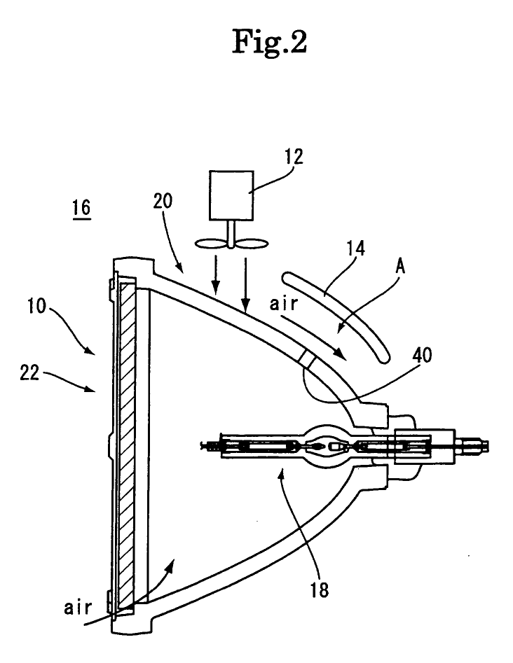

Ultra-high pressure discharge lamp unit 10 shown in FIG. 1 cooperates with a fan 12 and an air guide 14 to form a light source apparatus 16 for use in a projector, as shown in FIG. 2. The ultra-high pressure discharge lamp unit 10 includes an ultra-high pressure discharge lamp 18, a reflector 20 for reflecting light emitted from the ultra-high pressure discharge lamp 18, and a cover 22.

As shown in FIG. 1, the ultra-high pressure discharge lamp 18 includes a discharge tube 28 of quarts glass having a light-emitting bulb 24 and sealing portions 26 extending straight from opposite ends of the light-emitting bulb 24. In each of the sealing portions 26 are accommodated an electrode pin 30, a lead pin 32 and molybdenum foil 34 electrically interconnecting the electrode pin 30 and the lead pin 32. The end of each electrode pin 30 situated within the light-emitting bulb 24 is formed with a tungsten electrode 36. Within the light-emitting bulb 24 are encapsulated mercury at a pressure as high as 0.15 mg/mm³ or more, a rare gas, and a halogen.

Though there is no particular limitation on the size of the ultra-high pressure discharge lamp 18, the ultra-high pressure discharge lamp 18 desirably has a small size so as to exhibit enhanced brightness. In this embodiment, the ultra-high pressure discharge lamp 18 is sized so that the discharge tube 28 has a bulb wall loading of 0.8 W/mm² or more.

The reflector 20 as shown in FIG. 1 is configured to reflect light generated by the light-emitting bulb 24 of the ultra-high pressure discharge lamp 18 forwardly. The reflector 20 is formed from quartz glass and shaped parabolic with a concave reflective surface. The reflector 20 internally has a reflective mirror-finished surface and is centrally formed with a cylindrical lamp fitting portion 38 into which one of the sealing portions 26 of the ultra-high pressure discharge lamp 18 is to be inserted. Further, the reflector 20 has sidewall defining an exhaust vent hole 40 opening into an air passage A defined to extend along an external surface of the reflector 20. The exhaust vent hole 40 has a relatively small opening so as to prevent splinters from scattering upon possible explosion of the ultra-high pressure discharge lamp 18. In this embodiment the opening of the exhaust vent hole 40 is about φ3.

The cover 22 as shown in FIG. 1 is a sheet member of a translucent material, such as quartz glass, for closing the opening portion of the reflector 20.

In assembling the ultra-high pressure discharge lamp unit 10, first, one sealing portion 26 of the ultra-high pressure discharge lamp 18 is inserted into the lamp fitting portion 38 of the reflector and then the end portion of the sealing portion 26 is capped with a cap 42. Subsequently, the sealing portion 26 and the cap 42 are fixed to the lamp fitting portion 38 with cement 44, followed by fitting of the cover 22 over the opening portion of the reflector 20 with adhesive or the like.

In assembling the light source apparatus 16 using the ultra-high pressure discharge lamp unit, the ultra-high pressure discharge lamp unit 10 is placed in position within the projector and then the air guide 14 is positioned to define the air passage A along the external surface of the reflector 20. Further, the fan 12 is positioned upstream of the air passage A.

When using the projector, the ultra-high pressure discharge lamp 18 is turned on and the fan 12 is actuated. Then, air supplied to the air passage A from the fan 12 flows along the external surface of the reflector 20. At that time, flow of air does not occur within the reflector 20 and, hence, a flow rate difference results between the exterior and the interior of the reflector 20. A lower pressure is exerted on the exterior along which air flows at a higher flow rate than the pressure on the interior. Accordingly, heated air within the reflector 20 is discharged out of the reflector 20 through the exhaust vent hole 40 by suction caused by the relatively low (reduced) pressure and, as a result, the interior of the reflector 20 is cooled. When the internal pressure of the reflector 20 becomes negative due to discharge of heated air, external air is taken into the reflector 20 through miniscule clearances defined between components, including a clearance defined at the junction between the reflector 20 and the ultra-high pressure discharge lamp 18, and a clearance defined at the junction between the reflector 20 and the cover 22.

This embodiment uses the small-sized ultra-high pressure discharge lamp 18 in which mercury is encapsulated at a high pressure and hence can exhibit sufficient brightness. Further, since an undesirable elevation in the temperature of the ultra-high pressure discharge lamp 18 can be suppressed by discharging heated air out of the reflector 20, the ultra-high pressure discharge lamp 18 can be prevented from exploding and hence can enjoy prolonged lifetime.

The inventor of the present invention confirmed the effect of prolonging the lifetime of the ultra-high pressure discharge lamp 18 according to this embodiment by the following experiment. That is, there was provided the ultra-high pressure discharge lamp unit 10 including reflector 20 of F7.5 to which ultra-high pressure discharge lamp 18 of 180 W is adapted to light with direct current, and light source apparatus 16 was assembled as a sample using the ultra-high pressure discharge lamp unit 10, fan 12 and air guide 14. On the other hand, light source apparatus 16 which was identical with that used in the sample except that the exhaust vent hole 40 of the ultra-high pressure discharge lamp unit 10 was closed was provided as a comparative sample.

The sample and the comparative sample were tested for explosion at elapsed times of 2,000 hours, 3,000 hours, 4,000 hours, 5,000 hours and 6,000 hours. At the elapsed time of 6,000 hours the luminance retention rate (%) of each of the sample and the comparative sample was measured. The results of the experiment were as shown in Table 1. Note that the sample and the comparative sample were subjected to three runs in the experiment.

TABLE 1

| | | | | |
|---|---|---|---|---|
| 2,000 h | 3,000 h | 4,000 h | 5,000 h | 6,000 h |

Sample

| | | | | | |
|---|---|---|---|---|---|
| 1^{st} Run | 0 | 0 | 0 | 0 | 0 62% |
| 2^{nd} Run | 0 | 0 | 0 | 0 | 0 56% |
| 3^{rd} Run | 0 | 0 | 0 | 0 | 0 56% |

Comparative Sample

| | | | | |
|---|---|---|---|---|
| 1^{st} Run | 0 | 0 | 3,890 h | |
| 2^{nd} Run | 0 | 0 | 0 | 4,680 h |
| 3^{rd} Run | 0 | 0 | 0 | 4,890 h |

As can be seen from Table 1, the ultra-high pressure discharge lamp unit 10 and light source apparatus 16 according to this embodiment exhibited prolonged lifetime and kept a high luminance retention rate for a long time.

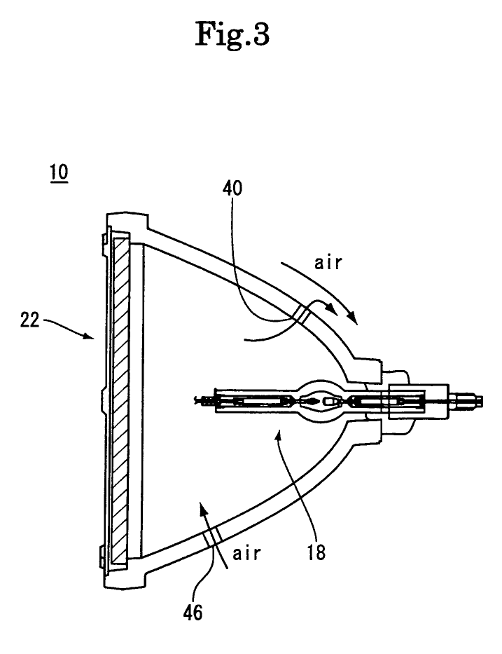

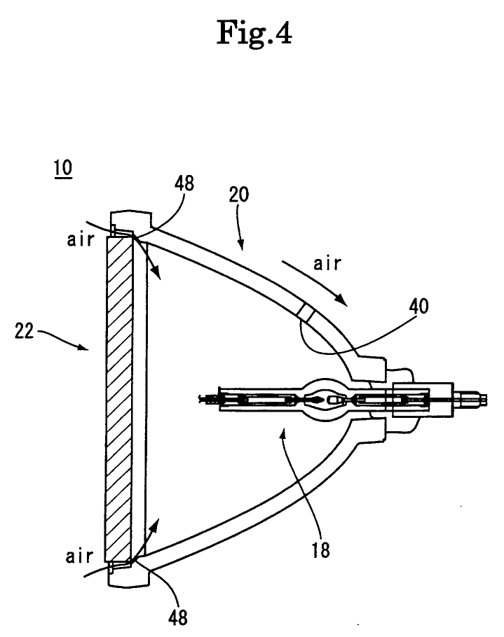

While the foregoing embodiment is configured to take relatively cool external air into the reflector 20 through miniscule clearances defined between components, it is possible that the sidewall of the reflector 20 is formed with an intake vent hole 46 at a location apart from the air passage A for taking relatively cool external air into the reflector 20 therethrough as shown in FIG. 3. Alternatively, an air intake channel 48 providing air communication between the exterior and the interior of the reflector 20 may be formed to take relatively cool external air into the reflector 20 therethrough as shown in FIG. 4.

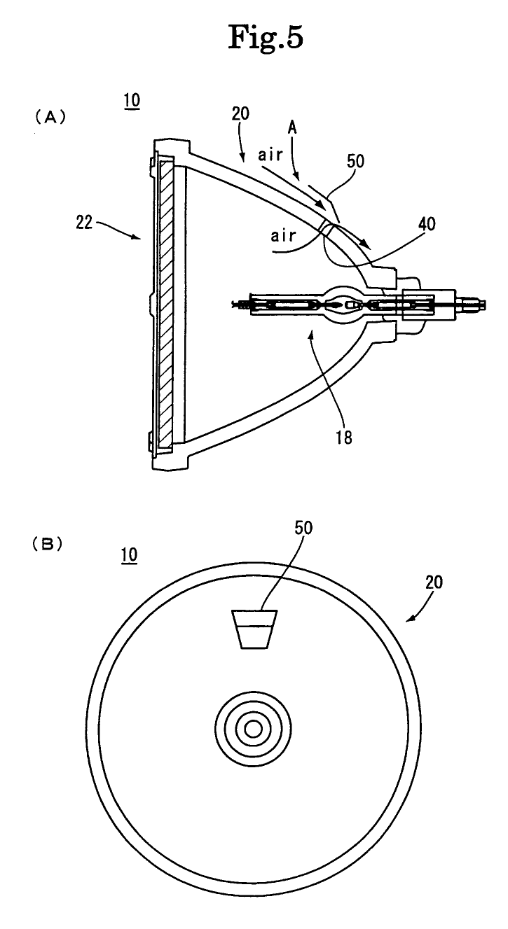

As shown in FIG. 5, the sidewall of the reflector 20 may be provided with a duct narrowing the air passage A at a location adjacent to the exhaust vent hole 40. In this case the flow rate of air at the narrowed portion of the air passage A is increased by the Venturi effect, which result in a further increased pressure difference between the exterior and the interior of the reflector 20. Accordingly, heated air within the reflector 20 can be discharged through the exhaust vent hole 40 more rapidly, which results in an outstandingly enhanced cooling efficiency.

While the foregoing embodiment uses the reflector 20 formed from quartz glass, the reflector 20 may be formed from metal such as aluminum, stainless steel, brass, nickel, chromium, nickel-chromium alloy, copper, or copper-nickel alloy. In this case the reflector 20 has a high thermal conductivity and, hence, a cooling effect based on heat dissipation can be expected.

While the reflector 20 used in the foregoing embodiment is shaped parabolic, the reflector 20 may have any shape which can form a concave reflective surface. For example, the opening portion of the reflector 20 may be shaped elliptic, square or rectangular.

While only certain presently preferred embodiments of the present invention have been described in detail, as will be apparent for those skilled in the art, certain changes and modifications may be made in embodiments without departing from the spirit and scope of the present invention as defined by the following claims.

1. An ultra-high pressure discharge lamp unit comprising: a reflector having a concave reflective surface; an ultra-high pressure discharge lamp fitted to a central portion of the reflector; and a translucent cover fitted over an opening portion of the reflector,
the reflector having sidewall defining an exhaust vent hole opening into an air passage defined to extend along an external surface of the reflector.

2. The ultra-high pressure discharge lamp unit according to claim 1, wherein the sidewall of the reflector defines an intake vent hole at a location apart from the air passage.

3. The ultra-high pressure discharge lamp unit according to claim 1 or 2, wherein the opening portion of the reflector and the cover define therebetween an air intake channel providing air communication between an interior and an exterior of the reflector.

4. The ultra-high pressure discharge lamp unit according to claim 1 or 2, wherein the sidewall of the reflector is provided with a duct narrowing the air passage at a location adjacent to the exhaust vent hole.

5. The ultra-high pressure discharge lamp unit according to claim 1 or 2, wherein the reflector is formed from metal.

6. The ultra-high pressure discharge lamp unit according to claim 1 or 2, wherein the ultra-high pressure discharge lamp has a discharge tube of quartz glass in which are encapsulated tungsten electrodes, mercury at a pressure of 0.15 mg/mm³ or more, a rare gas, and a halogen, and which has a bulb wall loading of 0.8 W/mm² or more.

7. A light source apparatus comprising: an ultra-high pressure discharge lamp unit as recited in claim 1 or 2; an air passage defined to extend along an external surface of the reflector; and a fan for supplying air to the air passage.
